(19) United States
(12) Patent Application Publication
(10) Pub. No.: US 2026/0233543 A1
(43) Pub. Date: Aug. 13, 2026

(54) Thermally-Sublimable Film Material

(71) Applicant: CHANCE LINE INDUSTRIAL CO., LTD., Siansi Township (TW)

(72) Inventors: Ming-Hsien YAO, Siansi Township (TW); Ling-Ching YAO, Siansi Township (TW); Chun-Hsien YAO, Siansi Township (TW); Shipeng WANG, Siansi Township (TW)

(21) Appl. No.: 19/534,121

(22) Filed: Feb. 9, 2026

(30) Foreign Application Priority Data
Feb. 10, 2025 (TW) 114104898

(51) Int. Cl. B41M 5/035; B41M 5/44; B41M 5/52

(52) U.S. Cl. CPC B41M 5/0355; B41M 5/44; B41M 5/5272; B41M 2205/02; B41M 2205/06; B41M 2205/38

(57) ABSTRACT

A thermally-sublimable film material comprises: a base layer, and an adhesive layer, a high-temperature barrier layer, and an ink-bonding layer sequentially disposed on the base layer, the ink-bonding layer is a polymer containing a polyester component. Thereby, when a thermal-sublimation ink is thermally-sublimated to the ink-bonding layer of the film material, the thermal-sublimation ink bonds with the polyester in the ink-bonding layer, enabling the thermal-sublimation ink to develop color and providing a pattern of the thermal-sublimation ink a vivid and vibrant color.

### FIELD OF THE INVENTION

The invention relates to a film material, specifically a film material capable of thermally sublimating patterns, enabling users to easily create thermal-sublimation patterns on the film material, and enabling a thermal-sublimation ink thermally-sublimated onto the film material to have a vivid color.

### DESCRIPTION OF THE RELATED ART

FIG. 1 shows a conventional plotter-cut film 10, which enables consumers to create patterns on clothing by DIY, providing the clothing with unique patterns.

The plotter-cut film 10 has a release paper 11, a hot melt adhesive layer 12, and a polyurethane (PU) layer 14. One method of creating a pattern on clothing with the plotter-cut film 10 is shown in FIGS. 2 to 4. Firstly, the plotter-cut film 10 is cut to a required size with dimensions larger than a desired pattern. Then, the release paper 11 is removed, and the plotter-cut film 10 is placed on a garment 19. The plotter-cut film 10 is then heat-pressed with an iron, as shown in FIG. 2, the hot melt adhesive layer 12 melts upon heating and generates viscosity, which causes the PU layer 14 to adhere to the garment 19. Then, a pattern 17 is printed on a thermal-sublimation paper 16 with a thermal-sublimation ink. The thermal-sublimation paper 16 is then brought into contact with the PU layer 14 of the plotter-cut film 10 as shown in FIG. 3, and an electric iron is used to apply a high temperature of 180°C or higher to the plotter-cut film 10 and the thermal-sublimation paper 16, so that the thermal-sublimation ink of the pattern 17 is thermally-sublimated onto the PU layer 14. The thermal-sublimation paper 16 is then peeled off, as shown in FIG. 4, so that the thermal-sublimation pattern 17 can be made on the garment 19.

Drawbacks of the above-described method are that a size of the plotter-cut film 10, which is firstly adhered to the garment 19, must be larger than a size of the pattern 17, and it is difficult to produce richly colored patterns and discontinuous patterns using this method.

An alternative method for creating patterns on clothing is shown in FIGS. 5 to 8. Firstly, the pattern 17 is printed onto the thermal-sublimation paper 16 using a thermal-sublimation ink. Then, the thermal-sublimation paper 16 is brought into contact with the PU layer 14 of the plotter-cut film 10, and the plotter-cut film 10 and the thermal-sublimation paper 16 are subjected to high temperature with an electric iron, as shown in FIG. 5, causing the pattern 17 to thermally sublimate onto the PU layer 14. The thermal-sublimation paper 16 is then peeled off, as shown in FIG. 6. Then, as shown in FIG. 7, the plotter-cut film 10 is cut, as indicated by a cut line C, and the release paper 11 is peeled off. Finally, as shown in FIG. 8, the plotter-cut film 10 with the thermal-sublimation pattern 17 is heat-pressed onto the garment 19 with an electric iron, and the PU layer 14 and the pattern 17 are adhered to a surface of the garment 19, providing the garment 19 with the pattern 17.

The alternative methods shown in FIGS. 5 to 8 present significant inconveniences and drawbacks for both consumers and manufacturers.

Firstly, in FIG. 5, when the pattern 17 is thermally-sublimated onto the plotter-cut film 10, an adhesive in the hot melt adhesive layer 12 melts and possesses fluidity. The release paper 11 is seamless, while the PU layer 14, coated on the hot melt adhesive layer 12, has pinholes. Therefore, the hot melt adhesive penetrates the PU layer 14, causing a surface of the PU layer 14 to adhere firmly to the thermal-sublimation paper 16. Consequently, after the pattern 17 is thermally sublimated, it is difficult for consumers to remove the thermal-sublimation paper 16, and a process of removing the thermal-sublimation paper 16 may damage the pattern 17.

Secondly, the hot melt adhesive adheres to the release paper 11, and a peel force between the hot melt adhesive layer 12 and the release paper is as high as 200-300 grams per inch of width, or even higher. This difficulty in separating the release paper 11 from the hot melt adhesive layer 12 makes it hard for consumers to remove the release paper 11, especially for small patterns, consumers find it difficult to peel the release paper 11 from the hot melt adhesive layer 12. The difficulty in peeling off the release paper 11 often results in damage to the plotter-cut film 10 and the pattern 17.

Due to the aforementioned drawbacks of this alternative method, the conventional thermal-sublimation process employs the approach shown in FIGS. 2 to 4, this involves firstly thermally bonding the plotter-cut film 10 to the garment 19, and then thermally sublimating the pattern 17 onto the PU layer 14 of the plotter-cut film 10. This alternative method is unsuitable for creating patterns.

Important drawbacks of the conventional plotter-cut film 10 include the fact that the thermal-sublimation ink combines with the PU layer 14, causing the thermal-sublimation ink to become unsaturated and lose its vividness, resulting in a color of the pattern 17 of the plotter-cut film 10 being dull and lacking luster. Furthermore, as shown in FIG. 9, after prolonged exposure, the thermal-sublimation ink in the conventional plotter-cut film 10 will spread, causing the thermal-sublimation pattern 17 to become blurry and unclear.

### SUMMARY OF THE INVENTION

The inventor aims to solve the aforementioned problems. One object of the invention is to provide a thermally-sublimable film material that enables a thermal-sublimation ink to sublimate into a vivid color on the film material.

One object of the invention is to provide a thermally-sublimable film material, the film material has an adhesive layer and a base layer. The invention is capable of achieving a low peel force between the adhesive layer and the base layer, making them easy to separate, thereby preventing damage to the film material and a thermal-sublimation pattern on the film material. Furthermore, when the pattern is thermally-sublimated onto the film material, it is not necessary to separate the base layer.

One object of the invention is to provide a thermally-sublimable film material capable of preventing the film material from sticking to a thermal-sublimation paper during creation of a thermal-sublimation pattern.

One object of the invention is to provide a thermally-sublimable film material, enabling a thermal-sublimation pattern on the film material to remain clear and unblurred even after a long period of time.

A thermally-sublimable film material provided by the invention comprising:

a base layer having release properties;

an adhesive layer disposed on the base layer;

a high-temperature barrier layer disposed on the adhesive layer, capable of withstanding temperatures higher than those at which the adhesive layer generating viscosity when heated; and

an ink-bonding layer disposed on the high-temperature barrier layer, the ink-bonding layer being a layer of polymer having a polyester component.

Thereby, when a thermal-sublimation ink is thermally sublimated to the ink-bonding layer of the film material, the thermal-sublimation ink bonds with the polyester in the ink-bonding layer, enabling the thermal-sublimation ink to develop color with saturated and vivid hues. A pattern created by the thermal-sublimation ink has a vivid and glossy luster. Furthermore, the thermal-sublimation pattern remains clear and does not blur even after a long period of time.

By thermally sublimating the pattern onto the film material, the high-temperature barrier layer is capable of blocking an adhesive of the adhesive layer, preventing the adhesive of the adhesive layer from passing through the high-temperature barrier layer and reaching the ink-bonding layer, making it easy for the film material to separate from a thermal-sublimation paper containing the thermal-sublimation ink.

Preferably, the ink-bonding layer is a layer of resin, such as a polyurethane resin layer, added with polyester powder. Preferably, the polyester powder has planar surfaces capable of reflecting light, providing the thermal-sublimation pattern a shimmering effect.

The ink-bonding layer is a polyester polymer containing ester groups (-COOR) in a structure thereof, such as polyethylene terephthalate (PET), polybutylene terephthalate (PBT), or thermoplastic elastomer (TPEE).

Preferably, a peel force between the adhesive layer and the base layer is between 20 grams and 150 grams per inch of width, making the adhesive layer easy to peel from the base layer. More preferably, the peel force is between 20 grams and 100 grams per inch of width, or between 20 grams and 80 grams per inch of width.

Preferably, the adhesive layer is made of hot melt adhesive, after the adhesive layer generates viscosity when heated, a peel force between the adhesive layer and the base layer is between 20 grams and 150 grams per inch of width, making the adhesive layer easy to peel from the base layer. More preferably, the peel force is between 20 grams and 100 grams per inch of width, or between 20 grams and 80 grams per inch of width.

Because a peel force between the base layer and the adhesive layer is low, the pattern can be directly thermally-sublimated onto the film material without prior peeling of the base layer. After the pattern is thermally-sublimated onto the film material, users can directly cut the film material, peel off waste materials other than the pattern, transfer the pattern using a transfer film, and heat press the pattern onto clothing.

Preferably, the high-temperature barrier layer is capable of withstanding temperatures above 170°C. Preferably, the high-temperature barrier layer is made of a high-temperature resistant thermoplastic polyurethane, polyurethane material, or polyester material.

Preferably, the adhesive layer is made of EVA hot melt adhesive, PSA pressure-sensitive adhesive (self-adhesive), thermoplastic polyurethane (TPU) hot melt adhesive, and polyethersulfone (PES) hot melt adhesive. According to the inventor's actual tests, a peel force between the adhesive layer using these materials and the base layer is between 20 grams and 100 grams per inch of width, making it easy to peel off.

Preferably, the ink-bonding layer or the high-temperature barrier layer is added with aluminum powder or pearlescent powder to enhance a light-reflecting effect of the film material. Tiny reflections of the aluminum powder are like flashes of light. A light reflected by the pearlescent powder is an iridescent light.

### BRIEF DESCRIPTION OF DRAWINGS

FIG. 1 is a cross-sectional view of a conventional plotter-cut film.

FIGS. 2 to 4 show a process of creating a thermal-sublimation pattern on a garment using a conventional plotter-cut film.

FIGS. 5 to 8 show another process of creating a thermal-sublimation pattern on the garment using a conventional plotter-cut film.

FIG. 9 is a photograph of a conventional plotter-cut film having a thermal-sublimation pattern.

FIG. 10 is a cross-sectional view of a thermally-sublimable film material according to a first preferred embodiment of the invention.

FIG. 11 is an enlarged schematic diagram of an ink-bonding layer of the film material of FIG. 10.

FIG. 12 is a photograph of the thermally-sublimable film material according to a preferred embodiment of the invention.

FIG. 13 is a partial enlarged view of FIG. 12.

FIGS. 14 to 26 illustrate a process of forming a pattern printed with a thermal-sublimation ink onto a fabric using the film material of the invention, wherein FIG. 18 shows a cross-sectional view of the thermal-sublimation ink thermally-sublimated onto the film material.

FIG. 27 shows a thermal-sublimation pattern formed on a fabric using the film material of the invention.

FIGS. 28A and 28B show another two thermal-sublimation patterns formed on a fabric using the film material of the invention.

FIG. 29 is a cross-sectional view of the thermally-sublimable film material according to a second preferred embodiment of the invention.

FIG. 30 is a cross-sectional view of the thermally-sublimable film material according to a third preferred embodiment of the invention.

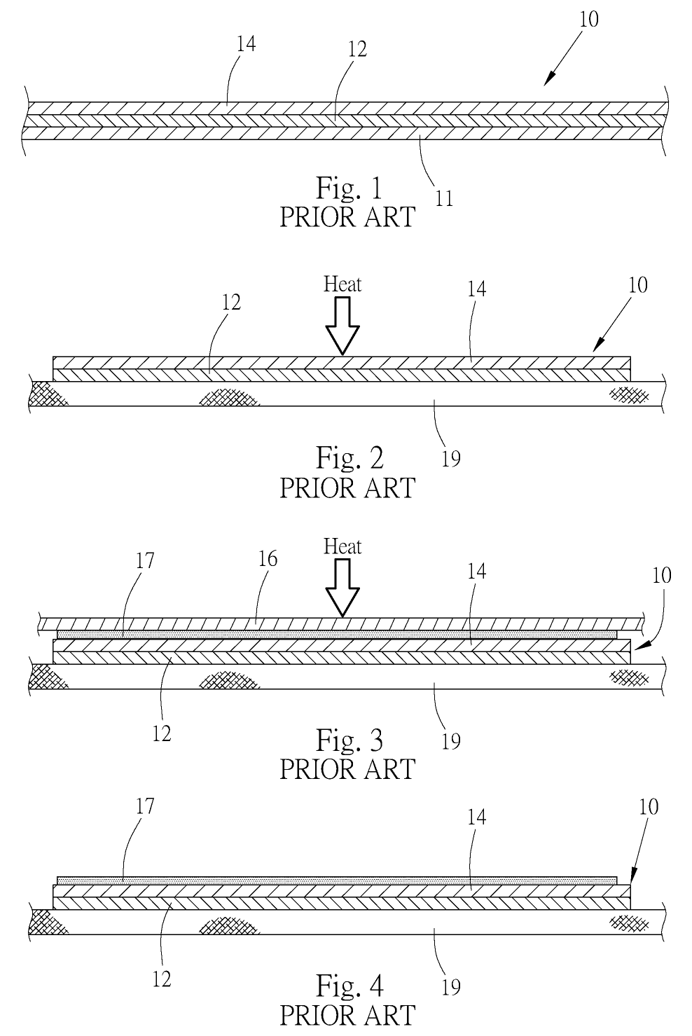

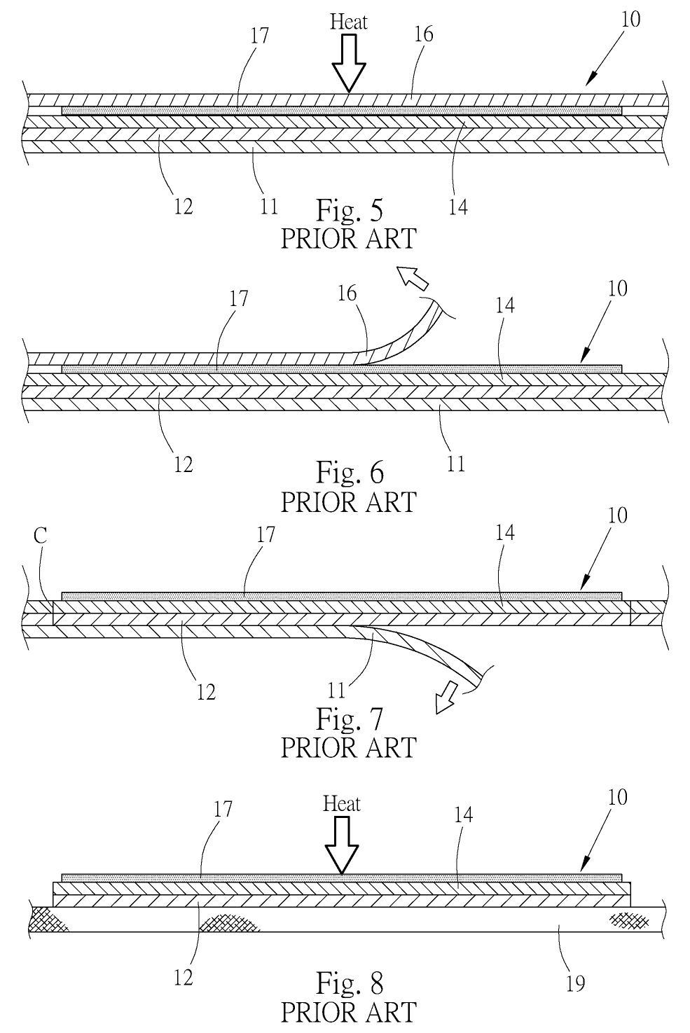

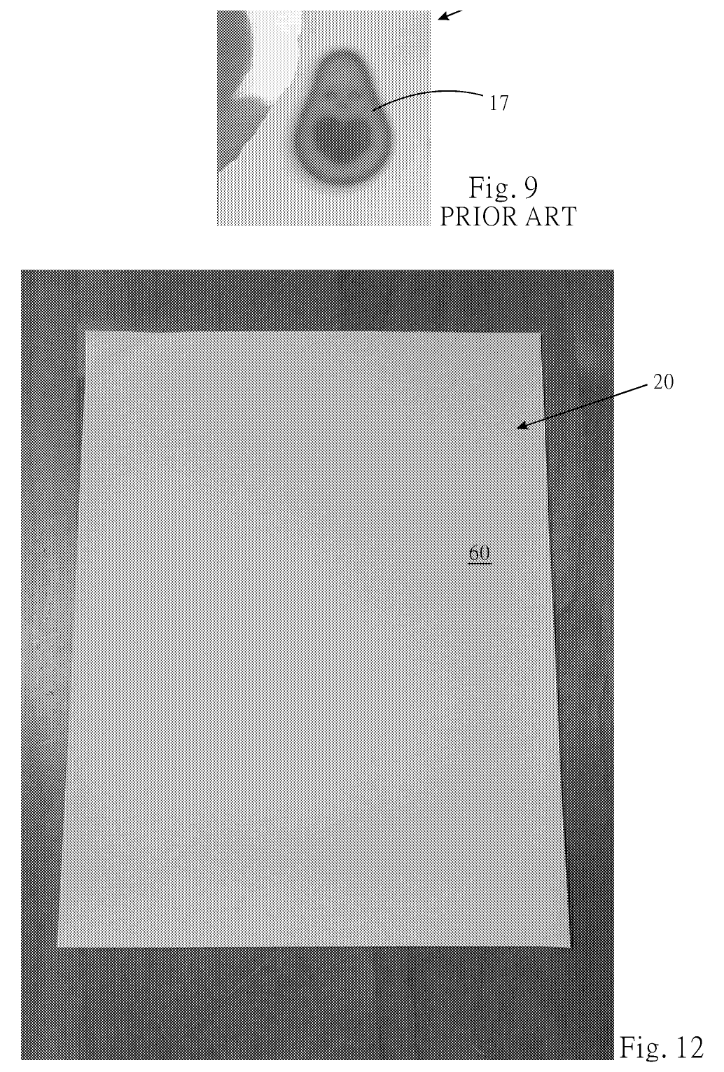

### DETAILED DESCRIPTION OF THE INVENTION

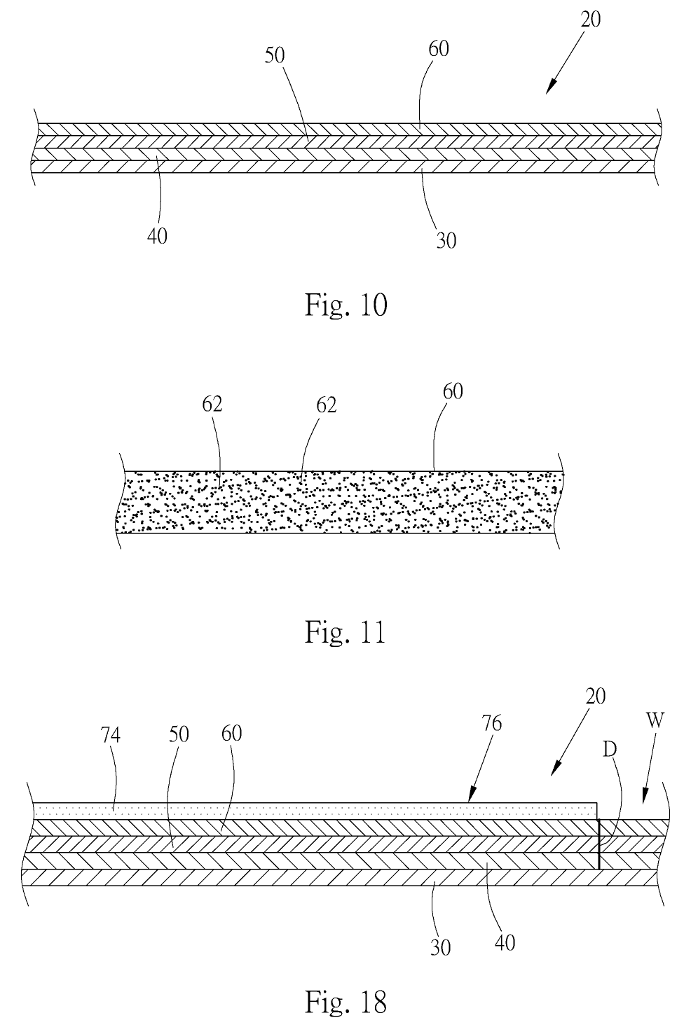

Please refer to FIG. 10, which shows a thermally-sublimable film material 20 provided in a first preferred embodiment of the invention. The thermally-sublimable film material 20 comprises: a base layer 30, an adhesive layer 40, a high-temperature barrier layer 50 and an ink-bonding layer 60 stacked together. The ink-bonding layer 60 is an outer layer of the film material 20 for bonding with a thermal-sublimation ink. Users can create thermal-sublimation patterns on the ink-bonding layer 60 of the film material 20.

The base layer 30 is a layer of carrier with release properties, which can be a release film or a release paper.

The adhesive layer 40 is disposed on one surface of the base layer 30. In the invention, after the adhesive layer 40 is subjected to a high temperature and generates viscosity, a peel force between the adhesive layer 40 and the base layer 30 is between 20 grams and 150 grams per 1 inch of width, preferably between 20 grams and 100 grams, and more preferably between 20 grams and 80 grams. Test conditions for the peel force are: the adhesive layer 40 and the base layer 30 are bonded together into a strip with a width of 1 inch, the adhesive layer 40 and the base layer 30 are pulled in opposite directions, and an acting force that can separate the adhesive layer 40 from the base layer 30 being the peel force. Therefore, after the film material 20 is heat-pressed, both adhesion force and peel force between the adhesive layer 40 and the base layer 30 are low, and the adhesive layer 40 and the base layer 30 can be easily separated. In this preferred embodiment, the adhesive layer 40 is a hot melt adhesive of the ethylene-vinyl acetate (EVA) copolymer series, which is solid at room temperature and melts into a viscous liquid adhesive (hot melt adhesive) when heated. The EVA hot melt adhesive layer 40 is polarized, making it easy to separate from the base layer 30 after the hot melt adhesive layer 40 generates viscosity. For the adhesive layer 40, pressure-sensitive adhesive (PSA) (also known as self-adhesive), or polarized thermoplastic polyurethane (TPU) hot melt adhesive, or polarized polyethersulfone (PES) hot melt adhesive can be used. According to the inventor's product and testing, a peel force between the adhesive layer 40 using these materials and the base layer 30 is between 20 grams and 150 grams per 1 inch of width. After the EVA hot melt adhesive layer 40 generates viscosity when heated, a peel force with the base layer 30 is 20~100 grams per inch of width, making it easy to separate. After the PES hot melt adhesive generates viscosity when heated, a peel force with the base layer 30 is also 20~100 grams per 1 inch of width.

The high-temperature barrier layer 50 is disposed on the adhesive layer 40 to isolate high temperatures and to isolate the adhesive layer 40, preventing an adhesive from the adhesive layer 40 from passing through the high-temperature barrier layer 50 and spreading to the ink-bonding layer 60. Preferably, the high-temperature barrier layer 50 is capable of withstanding high temperatures above 180°C, more preferably, capable of withstanding high temperatures above 210°C, for example, 215~225°C. In this preferred embodiment, the high-temperature barrier layer 50 is a high-temperature resistant thermoplastic polyurethane or polyurethane. Preferably, the high-temperature barrier layer 50 is a layer of high-temperature resistant thermoplastic polyurethane (TPU) coated on the adhesive layer 40, capable of withstanding the aforementioned high temperatures.

Please refer to FIG. 11. The ink-bonding layer 60 is a polyurethane (PU) resin layer added with an appropriate amount of polyester (PET) powder 62. The polyester powder 62 is added to liquid polyurethane, and then the liquid polyurethane is coated onto the high-temperature barrier layer 50 to form the ink-bonding layer 60. The polyester powder 62 is uniformly distributed in the ink-bonding layer 60, providing the ink-bonding layer 60 with a polyester component. The polyester powder 62 can be transparent or translucent powder, colored powder, or colored and transparent or translucent powder. Preferably, the polyester powder 62 is made from tiny particles cut from a polyester film or ground from polyester granules, has planar surfaces capable of reflecting light.

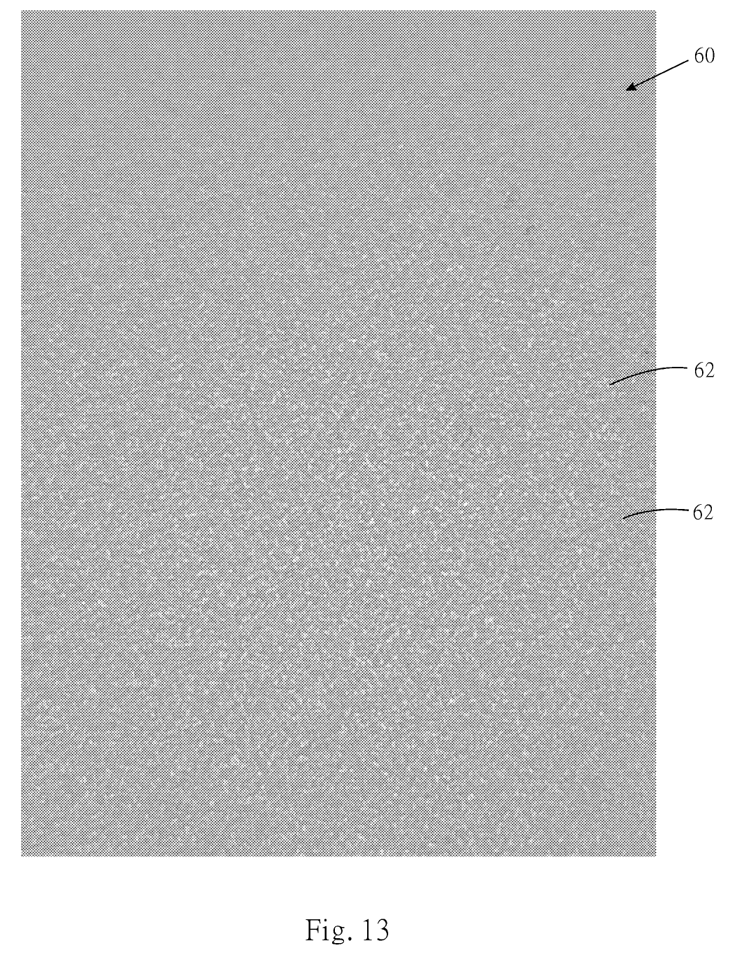

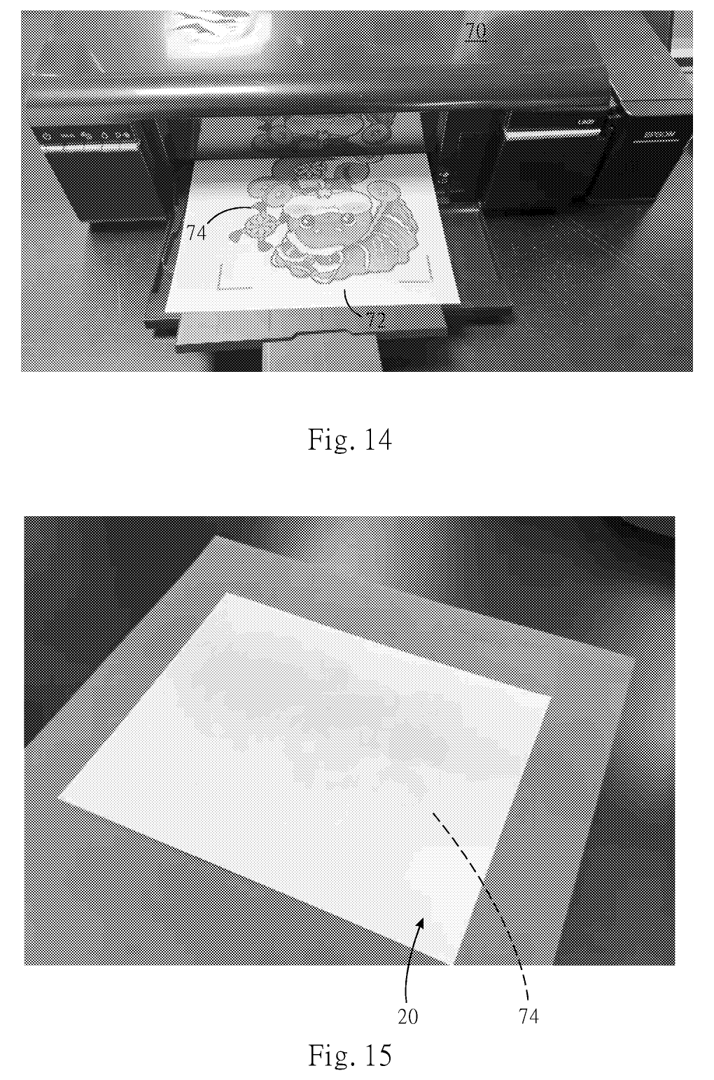

FIGS. 12 and 13 are respectively a photograph and a partial enlarged view of the film material 20 of the first preferred embodiment of the invention, showing that the ink-bonding layer 60 contains the polyester powder 62.

The following describes a process of using the film material 20 of the invention in conjunction with a thermal-sublimation paper to thermally sublimate text or non-text patterns onto a fabric (e.g., clothing). The adhesive layer 40 of the film material 20 is exemplified by EVA hot melt adhesive.

Please refer to FIG. 14, a user uses a household printer 70 to print a colored pattern 74 onto a thermal-sublimation paper 72 using the thermal-sublimation ink. This pattern 74 can be text (e.g., the English letters A, B, C) or non-text (e.g., people, landscapes, objects, symbols, etc.). The pattern 74 in FIG. 14 uses a cute animal as an example.

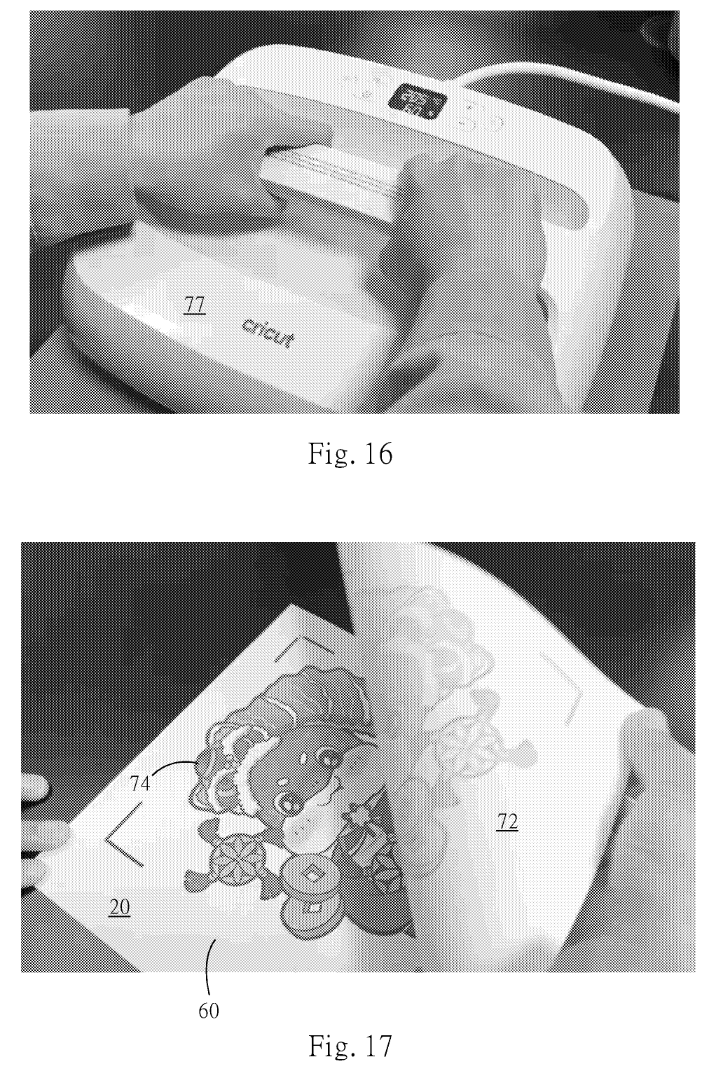

Please refer to FIG. 15, a film material 20 of the invention and the thermal-sublimation paper 72 printed with the pattern 74 are overlapped, with the pattern 74 in contact with the ink-bonding layer 60 of the film material 20. Then, a heat press 77 or an iron is used to heat press the film material 20 and the thermal-sublimation paper 72, as shown in FIG. 16, for example, at a temperature of 205°C for 60 seconds.

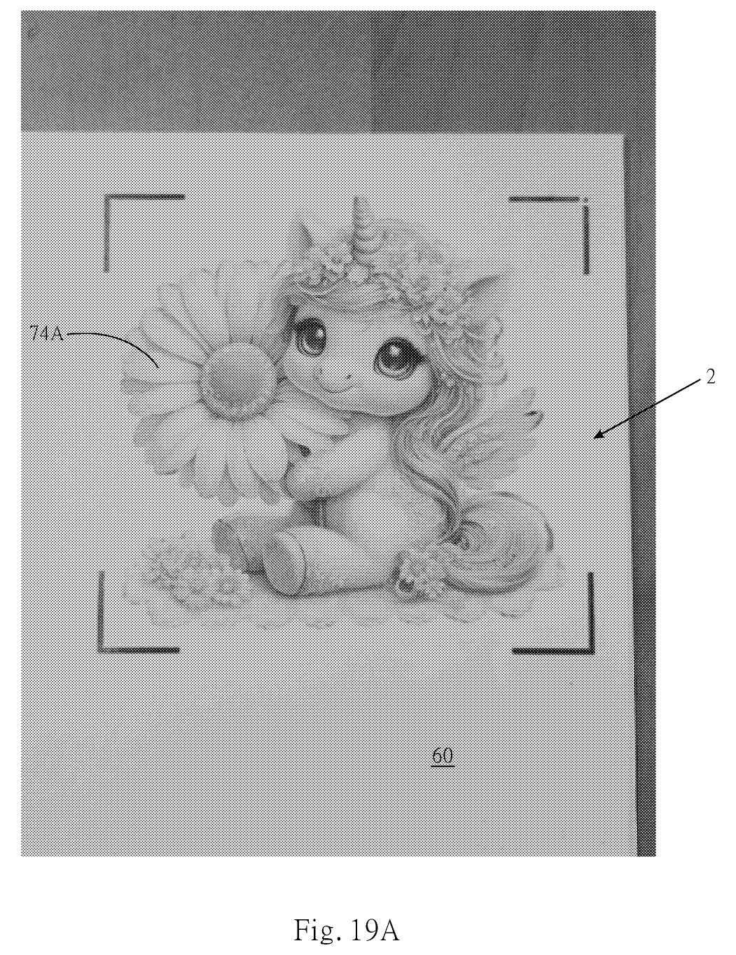

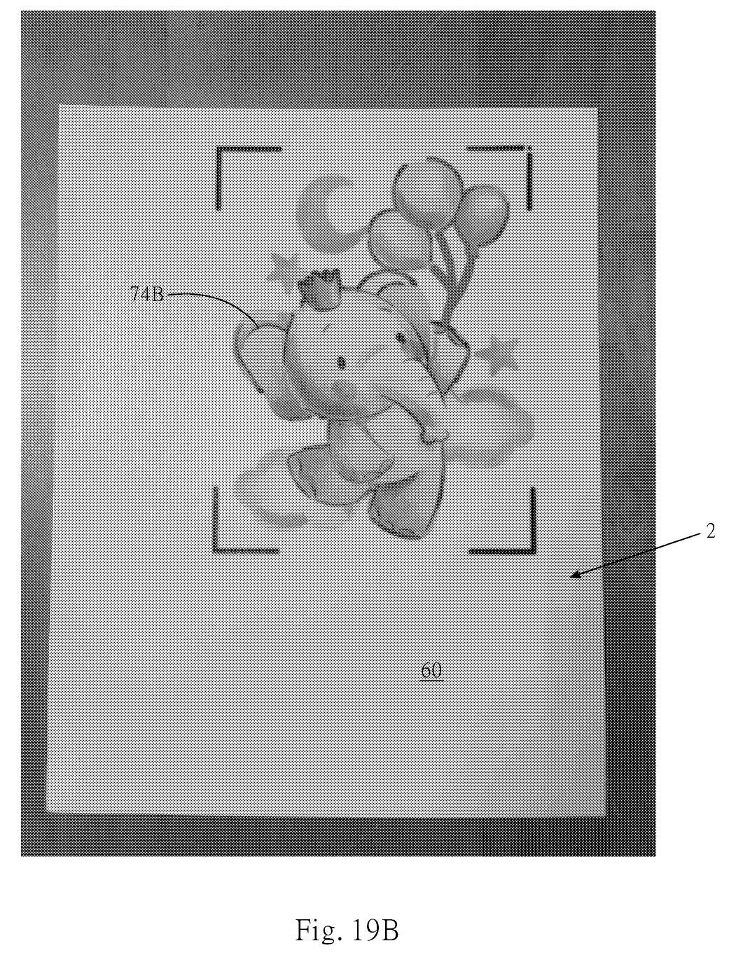

After heat pressing as shown in FIG. 16, the thermal-sublimation ink on the thermal-sublimation paper 72 is thermally sublimated onto the ink-bonding layer 60 of the film material 20. As shown in FIG. 17, the thermal-sublimation paper 72 is separated from the film material 20, revealing that the thermal-sublimation ink of the pattern 74 is thermally sublimated onto the ink-bonding layer 60. Please refer to FIG. 18, the thermal-sublimation ink of the thermal-sublimation pattern 74 is bonded to the ink-bonding layer 60. FIGS. 19A and 19B show another two film materials 20 of the invention, the film materials 20 are provided with another two colored thermal-sublimation patterns 74A, 74B on the ink-bonding layers 60.

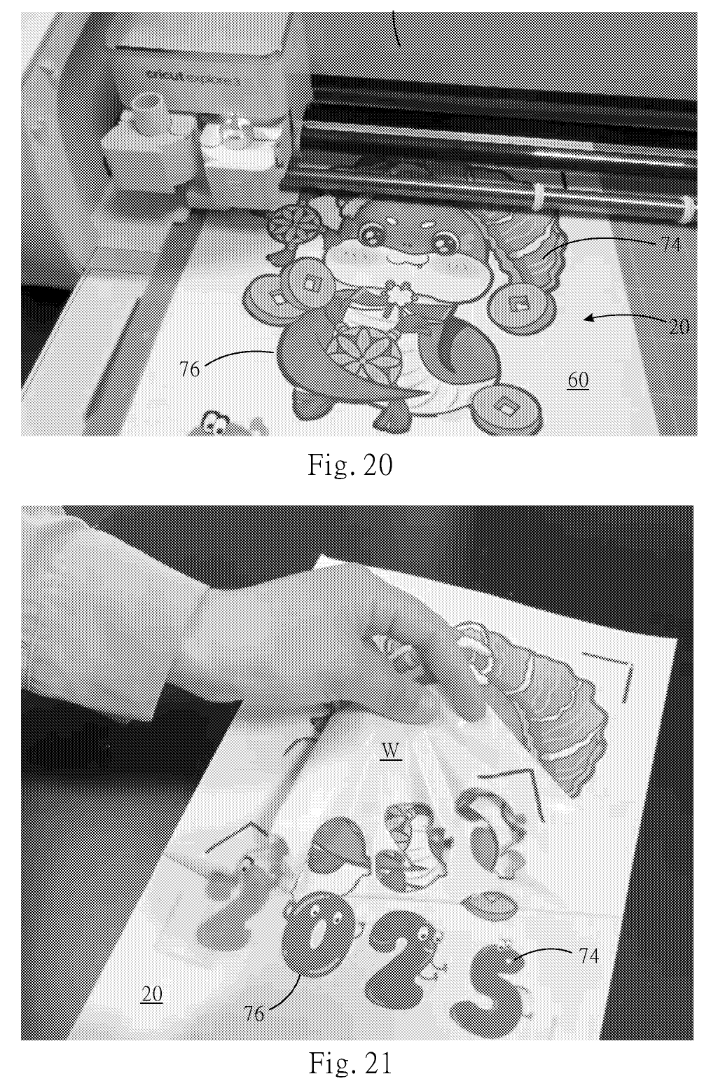

Subsequently, as shown in FIG. 20, a graphic 76 is cut from an outline of the pattern 74 using a household cutting machine 78. A cutting depth D of a cutter, as shown in FIG. 18, cuts through the ink-bonding layer 60, the high-temperature barrier layer 50, and the adhesive layer (hot melt adhesive layer) 40, but does not cut through the base layer 30. After cutting, a waste material W is removed other than the graphic 76, as shown in FIG. 21, leaving only the graphic 76 on the film material 20.

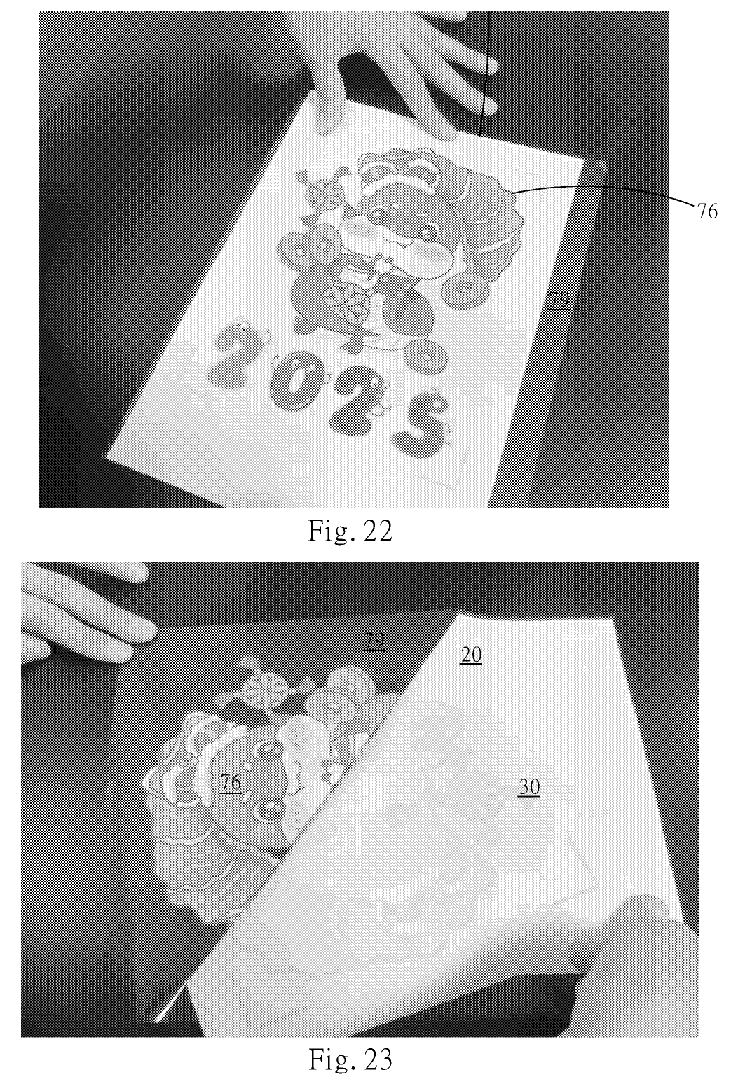

Then, as shown in FIG. 22, a transfer film 79 is adhered to the graphic 76, and the graphic 76 is then separated from the base layer 30 of the film material 20 by the transfer film 79, as shown in FIG. 23. The graphic 76 has the thermal-sublimation pattern 74, the ink-bonding layer 60, the high-temperature barrier layer 50 and the adhesive layer 40.

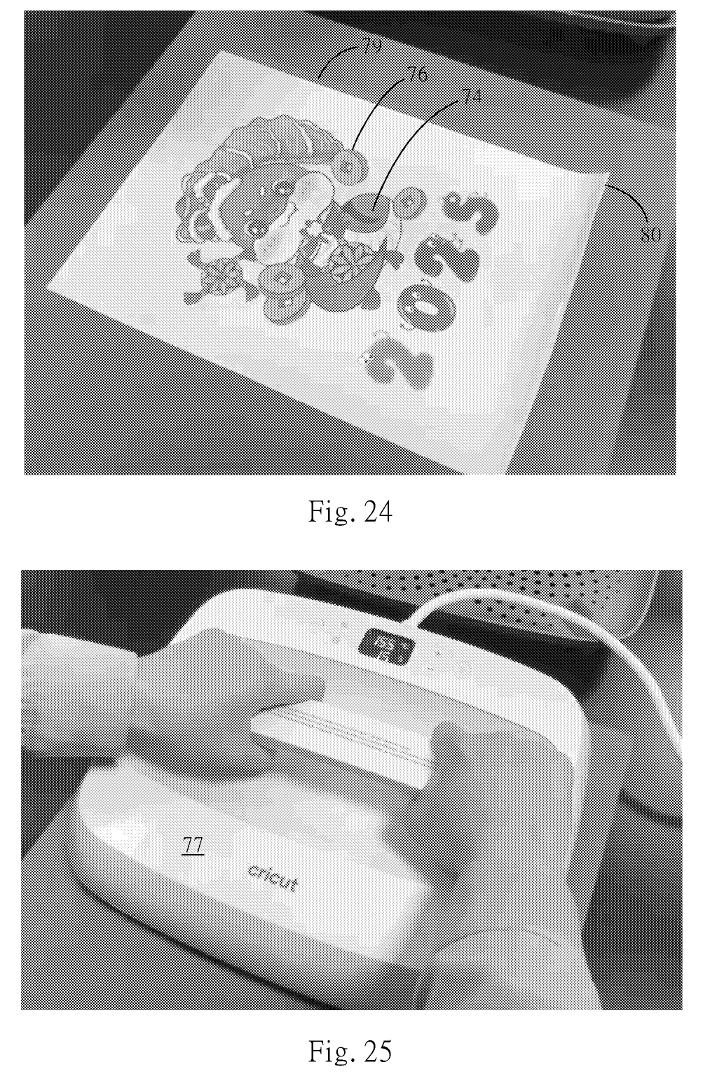

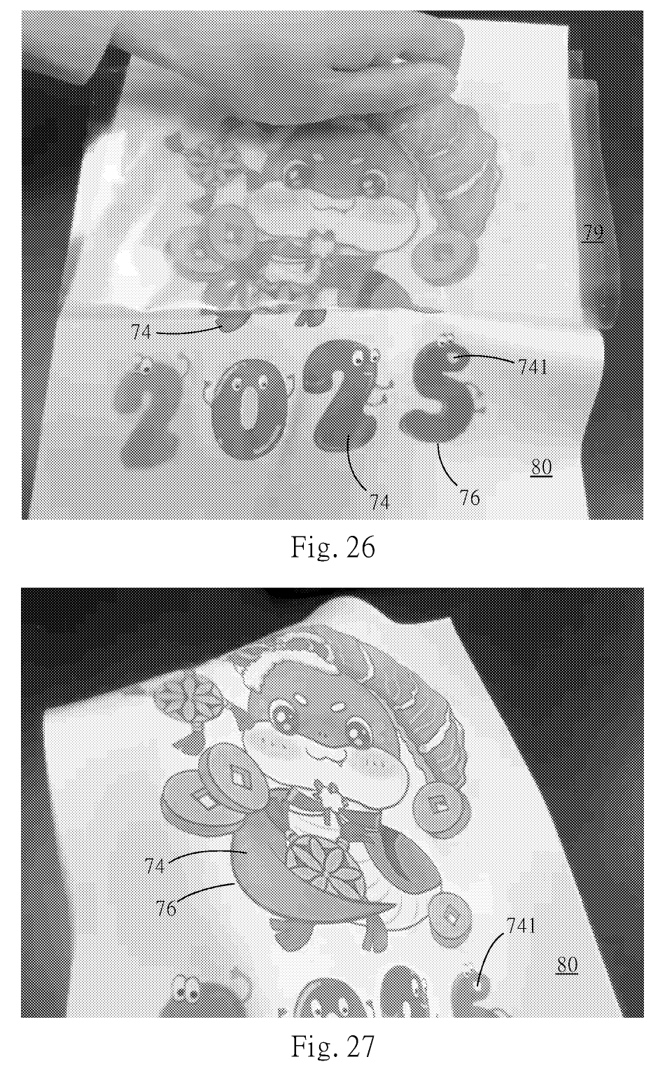

Please refer to FIG. 24, the graphic 76 is placed on a fabric 80 using the transfer film 79, so that the adhesive layer (hot melt adhesive layer) 40 of the graphic 76 contacts the fabric 80, and the graphic 76 is heat-pressed, as shown in FIG. 25, for example, at a temperature of 145°C for 30 seconds, or at a temperature of 155°C for 15 seconds. After heat pressing, the transfer film 79 is removed, as shown in FIG. 26, the graphic 76 (including the pattern 74) is adhered to the fabric 80 by an adhesive of the adhesive layer 40. FIG. 27 shows a finished product of the graphic 76 (including the pattern 74) heat-pressed onto the fabric 80.

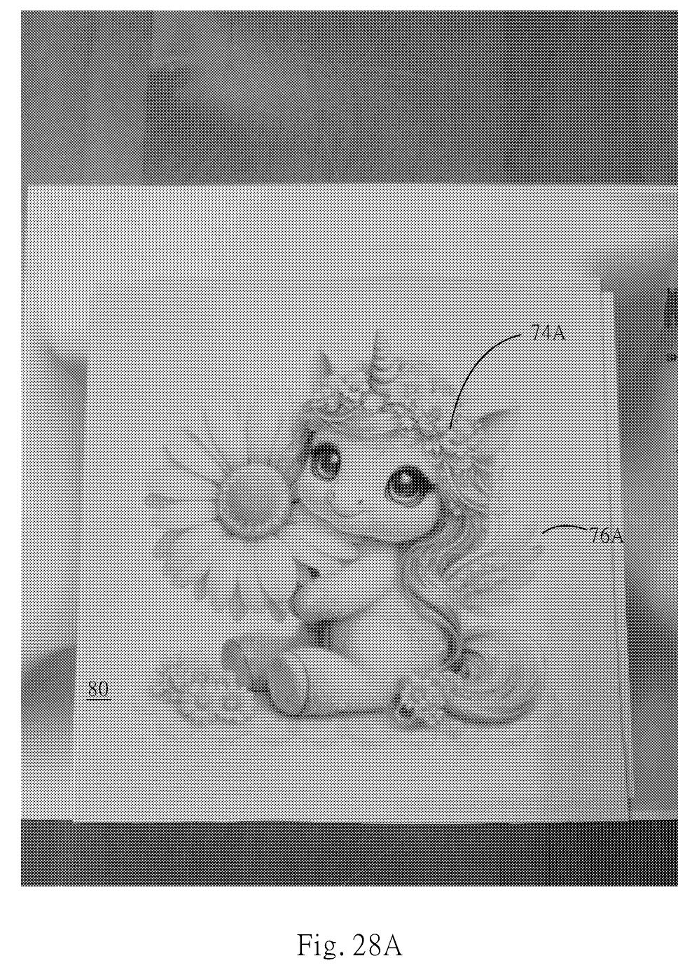

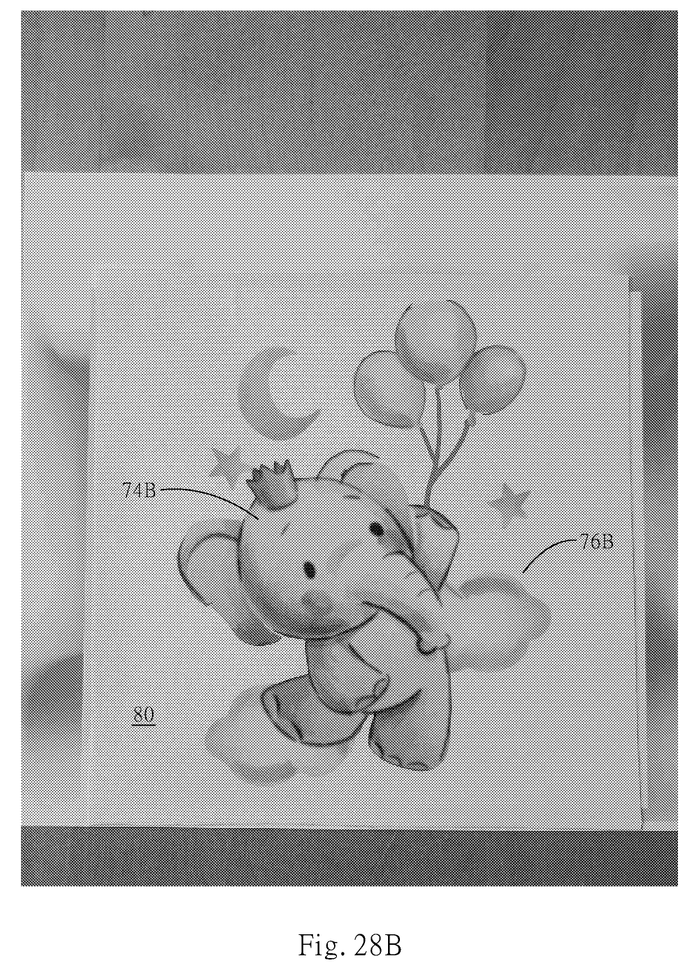

FIGS. 28A and 28B show another two graphics 76A, 76B heat-pressed onto fabrics 80, the two graphics 76A, 76B present another two thermal-sublimation patterns 74A, 74B.

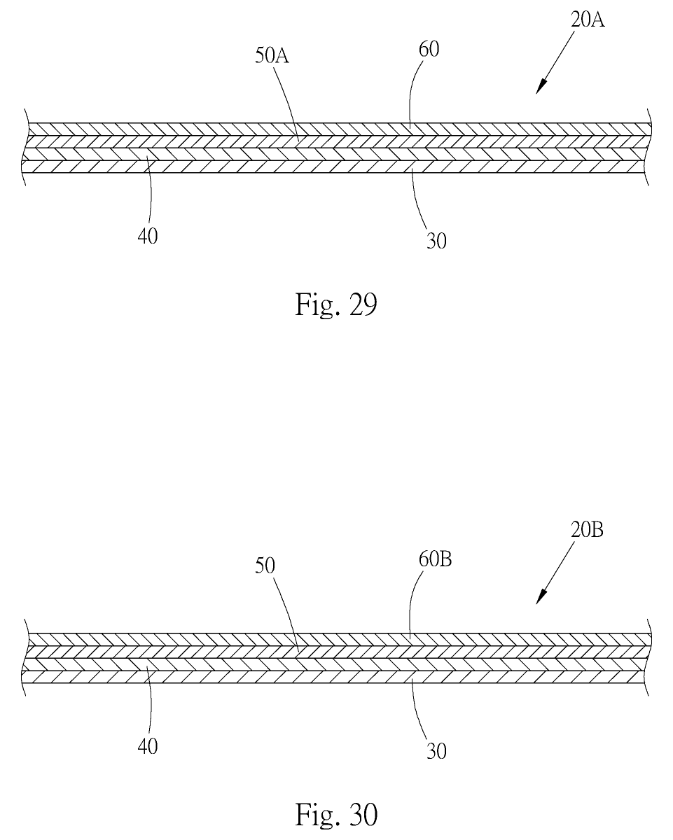

FIG. 29 shows a thermally-sublimable film material 20A provided in a second preferred embodiment of the invention, comprising: a base layer 30, and an adhesive layer 40, a high-temperature barrier layer 50A and an ink-bonding layer 60 sequentially stacked on the base layer 30. The base layer 30, the adhesive layer 40 and the ink-bonding layer 60 are the same as those shown in the first preferred embodiment, and will not be described again. In this preferred embodiment, the high-temperature barrier layer 50A is a polyester (PET) layer capable of withstanding temperatures above 210°C without melting. Through a process shown in FIGS. 14 to 26, a thermal-sublimation pattern can be formed on the ink-bonding layer 60 of the film material 20A.

FIG. 30 illustrates a thermally-sublimable film material 20B provided in a third preferred embodiment of the invention, comprising: a base layer 30, an adhesive layer 40, a high-temperature barrier layer 50, and an ink-bonding layer 60B. The base layer 30 and the adhesive layer 40 are the same as those shown in the first preferred embodiment, and will not be described again. The high-temperature barrier layer 50 can be the high-temperature barrier layer shown in the first or second preferred embodiment.

The ink-bonding layer 60B in this preferred embodiment is a polyester polymer containing ester groups (-COOR) in a structural unit thereof, such as polyethylene terephthalate (PET), polybutylene terephthalate (PBT), and thermoplastic elastomer (TPEE). Through a process shown in FIGS. 14 to 26, a thermal-sublimation pattern can be formed on the ink-bonding layer 60B of the film material 20B, and a thermal-sublimation ink of the pattern can be bonded to the polyester of the ink-bonding layer 60B.

Further, in the invention, aluminum powder or pearlescent powder can be added to the thermal bonding layers 60, 60B of the film materials 20, 20B, or to the high-temperature barrier layers 50, 50A of the film materials 20, 20A to enhance a light reflection effect of the film materials 20, 20A, 20B. Fine aluminum powder produces tiny light reflections, similar to a shimmering effect. Pearlescent powder reflects an iridescent light (multicolored light).

The film material 20 (20A, 20B) provided by the invention is capable of solving the drawbacks of the prior art. The ink-bonding layer 60 (60B) of the film material 20 is provided with polyester. When the thermal-sublimation ink of the pattern 74 (74A, 74B) is thermally sublimated to the ink-bonding layer 60, the thermal-sublimation ink bonds with the polyester material of the ink-bonding layer 60. The polyester enables the thermal-sublimation ink to develop color, making a color of the thermal-sublimation ink saturated and vivid. The pattern 74 has a bright, vivid color and a glossy finish. Furthermore, because the ink color is distinct, it is suitable for printing the pattern 74 in multiple colors with the thermal-sublimation ink. The patterns 74, 74A, and 74B in FIGS. 27, 28A, and 28B all have multiple colors, and the colors are vivid and lines of the patterns 74, 74A, and 74B are delicate.

By bonding the thermal-sublimation ink with polyester, the ink will not spread, and the thermal-sublimation patterns 74, 74A, and 74B will remain clear and unblurred even after a long period of time.

The film material 20 of the invention enables consumers and businesses to easily create various thermal-sublimation patterns 74 on the film material 20 and adhere the thermal-sublimation patterns 74 to a fabric, as shown in a manufacturing process in FIGS. 14 to 26. A peel force between the adhesive layer 40 and the base layer 30 is between 20 grams and 80 grams per square centimeter, making it easy to separate. In a heat pressing process shown in FIG. 16, when the thermal-sublimation ink of the thermal-sublimation paper 72 is thermally-sublimated onto the ink-bonding layer 60 of the film material 20, the hot melt adhesive layer 40 generates viscosity when heated. Because a peel force between the hot melt adhesive layer 40 and the base layer 30 is low, the hot melt adhesive layer 40 can be easily separated from the base layer 30. Therefore, when removing the waste material W as shown in FIG. 21, a user can easily tear off and remove the waste material W, and easily remove fine waste materials in the pattern 74, such as a small triangular waste material in the letter A, and a small waste in a small hollow area 741 of the pattern 74 as shown in FIG. 27. A design of the hot melt adhesive layer 40, which is easily separable from the base layer 30, facilitates removal of fine and complex waste materials. Because the base layer 30 is easily separable from the hot melt adhesive layer 40, the base layer 30 can be easily and smoothly peeled off without damaging the thermal-sublimation pattern 74 and the film material 20. Since the hot melt adhesive layer 40 can be easily separated from the base layer 30 after the pattern 74 is thermally-sublimated onto the film material 20, the invention enables the graphic 76 to be cut on the plotter-cut film 20 without peeling off the base layer 30, so that a size of the ink-bonding layer 60 is comparable to a size of the pattern 74. The base layer is then peeled off after the graphic is cut.

In the invention, because the high-temperature barrier layers 50, 50A are disposed under the ink-bonding layer 60, an adhesive of the adhesive layer 40 can be prevented from spreading upward to the ink-bonding layer 60. Therefore, during a thermal-sublimation process of the pattern 74 in FIG. 16, the thermal-sublimation paper 72 will not stick to the adhesive layer 40, making it easy to separate the thermal-sublimation paper 72 from the film material 20. In FIG. 25, when the graphic 76 is heat-pressed and adhered to the fabric 80, the high-temperature barrier layer 50 is capable of blocking an adhesive of the adhesive layer 40, preventing the adhesive from spreading upward to the ink-bonding layer 60 and the ink of the pattern 74.

The film material 20 of the invention enables consumers and businesses to create thermal-sublimation patterns according to a process shown in FIGS. 14 to 26. This method can produce discontinuous patterns. Discontinuous patterns are shown in FIGS. 26 and 27, where the four Arabic numerals 2025 in the pattern 74 are separate and discontinuous.

The polyester powder 62 in the ink-bonding layer 60 has a light-reflective effect, causing the thermal-sublimation pattern 74 to have a shimmering effect when light shines on it.

The film material 20 of the invention enables individuals or businesses to create their own preferred thermal-sublimation pattern 74. Manufacturers of the film material 20 only need to produce small quantities of different styles for sale, thereby reducing display and storage spaces for goods sold, lowering manufacturing and inventory costs, and meeting environmental protection requirements.

Although the invention has been disclosed as above with the embodiments, they are not intended to limit the invention. A person having ordinary skill in the art to which the invention pertains can make various changes and modifications without departing from the spirit and scope of the invention. Therefore, a scope of protection of the invention shall be subject to what is defined in the pending claims.

What is claimed is:

1. A thermally-sublimable film material comprising:
a base layer having release properties;
an adhesive layer disposed on the base layer;
a high-temperature barrier layer disposed on the adhesive layer, capable of withstanding temperatures higher than those at which the adhesive layer generating viscosity when heated; and
an ink-bonding layer disposed on the high-temperature barrier layer, the ink-bonding layer being a layer of polymer containing a polyester component.

2. The film material as claimed in claim 1, wherein the ink-bonding layer is a layer of resin, and the ink-bonding layer has polyester powder.

3. The film material as claimed in claim 2, wherein the ink-bonding layer is made of a polyurethane material.

4. The film material as claimed in claim 1, wherein the ink-bonding layer is a polyester polymer containing ester groups (-COOR).

5. The film material as claimed in claim 4, wherein the ink-bonding layer is polyethylene terephthalate (PET), polybutylene terephthalate (PBT) or thermoplastic elastomer (TPEE).

6. The film material as claimed in claim 1, wherein a peel force between the adhesive layer and the base layer is between 20 grams and 150 grams per inch of width.

7. The film material as claimed in claim 1, wherein the adhesive layer is made of hot melt adhesive, after the adhesive layer generates viscosity when heated, a peel force between the adhesive layer and the base layer is between 20 grams and 150 grams per inch of width.

8. The film material as claimed in claim 1, wherein the high-temperature barrier layer capable of withstanding temperatures above 170°C.

9. The film material as claimed in claim 1, wherein the high-temperature barrier layer is made of high-temperature resistant thermoplastic polyurethane or polyurethane or polyester.

10. The film material as claimed in claim 1, wherein the adhesive layer is made of hot melt adhesive or pressure-sensitive adhesive.

11. The film material as claimed in claim 10, wherein the hot melt adhesive is an ethylene-vinyl acetate (EVA) hot melt adhesive, a polyethersulfone (PES) hot melt adhesive, or a thermoplastic polyurethane (TPU) hot melt adhesive.

12. The film material as claimed in claim 2, wherein the polyester powder is capable of reflecting light.

13. The film material as claimed in claim 1, wherein the ink-bonding layer or the high-temperature barrier layer is added with aluminum powder or pearlescent powder.

14. The film material as claimed in claim 1, wherein a thermal-sublimation ink is thermally sublimated to the ink-bonding layer of the film material, the thermal-sublimation ink bonds with the polyester in the ink-bonding layer.
